(19) United States
(12) Patent Application Publication
(10) Pub. No.: US 2021/0197901 A1
(43) Pub. Date: Jul. 1, 2021

(54) VEHICLE ROOF RACK DOWNFORCE WING

(71) Applicant: Dmytro Poluektov, Seattle, WA (US)

(72) Inventor: Dmytro Poluektov, Seattle, WA (US)

(21) Appl. No.: 16/729,439

(22) Filed: Dec. 29, 2019

(51) Int. Cl. B62D 35/00

(52) U.S. Cl. CPC B62D 35/00

(57) ABSTRACT

An downforce wing on a vehicle roof rack is horizontally secured by a set of clamps, each clamp secured independently of each other on a vehicle roof rack crossbar. The downforce wing is vertically secured on its back end by the said clamps' with roof pedestals attached to them, which support the downward force generated by the downforce wing and is vertically secured by the downforce wing roof base itself on its front end. The base size of the downforce wing roof pedestals varies to support downforce wings of various sizes and downward force performance. Should any of the clamps loosen due to a mechanical failure, the remaining clamps will keep securing the downforce wing to the roof rack crossbar.

This invention relates to to vehicular downforce wing performance accessories and more particular to roof mounted downforce wings attached to automotive carrier racks to increase vehicular downward traction force.

### BACKGROUND AND SUMMARY OF THE INVENTION

Downforce wings have been commonly manufactured in a wide variety of shapes, depending on a wide variety of vehicles they are installed on. They are most typically mounted directly on top of vehicle trunk to increase the rear traction. It is critical for the downforce wings to be effectively secured to the vehicle body so that will not detach when experiencing high force loads of air resistance under high speed conditions. As downforce wings are designed to produce downforce, the primary force vector exerted on them is primarily downward, however there is also a secondary horizontal force vector component as a byproduct of aerodynamic drag. As such, downforce wings are typically bolted on and installed in the back due to having convenient, unobtrusive and sturdy location to install on top of the trunk, directly and permanently attached to the vehicular chassis.

However there are some detrimental effects reducing efficiency of vehicular rear wings, primarily due to air turbulence in the back of the vehicular slipstream. As the vehicle pushes through the air masses at high speed, this creates whirlwinds in the back. These whirlwinds then hit the downforce wings typically installed in the rear. This reduces the effectiveness of the rear wings due to the reduced air pressures applied on them. Additionally due to the turbulence, the force applied on the rear wings is inconsistent, contributing to vehicle instability in corners. This is highly undesirable as downforce wings are primarily designed for the purposes of increasing vehicle stability and traction.

The present invention allows for additional vehicle traction and stability by leveraging roof rack installations to install downforce wings not in the rear but on the vehicle roof, which offers a number of advantages. The primary advantage is the more stable airflow in the mid section of vehicle as compared to the rear, allowing for a smoother downforce delivery. Additionally, roof wing still allows for the installation of the rear wing as the same time, for additional downforce generation as well. Another advantage of roof rack mounted downforce wings is their modular functionality, allowed them to be removed from the roof rack crossbars such as found in Grim, U.S. Pat. No. 4,877,169 via removal of the clamps attaching roof downforce wing to the roof rack. This allows for multipurpose cargo and performance use of vehicular roof racks. Finally, installing a downforce wing in the mid chassis allows for more even downforce distribution when compared to rear wing installations which in turn helps to prevent understeer.

More specifically, in this design, the roof downforce wing attaches to the roof rack crossbar via a joint, most simply via clamp, but other similar connection methods are possible. The roof rack crossbar serves as a secondary load bearer for the secondary horizontal drag forces generated by the downforce wing. The downforce wing roof pedestals also attach to the said clamp joints and are placed on the roof floor to serve as the primary load bearers of the primary downward forces generated by the downforce wing. Preferred embodiments of the invention also include lock washers at all bolt on connections to avoid loosening.

Additional clarification of the functionality and benefits and details will be elucidated in the following descriptions.

### BRIEF DESCRIPTION OF THE DRAWINGS

FIG. 1 is a cutaway view of the roof downforce air wing, its attachment mechanism, as well as the vehicle roof rack and the vehicle roof it is attached to.

FIG. 2 is a side perspective view of the roof downforce air wing clamps mounted on the crossbar as well as view of the vehicle roof rack crossbar, vehicle roof rack and the vehicle roof it is attached to.

### DETAILED DESCRIPTION OF THE INVENTION AND PREFERRED EMBODIMENTS

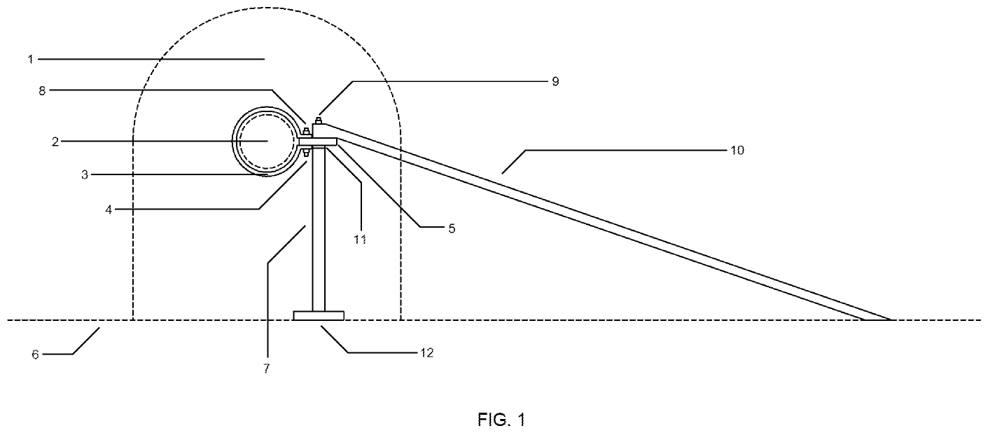

A sample downforce roof wing installation design in accordance with the present invention is demonstrated in a cutaway FIG. 1. In this figure, the roof downforce wing 10 is shown mounted to the roof rack crossbar on an automobile roof 6. The roof wing is mounted to the automobile roof through the use of a roof rack consisting of roof rack pedestal 1 and roof rack crossbar 2. Specifically, the roof wing is attached to the roof rack crossbar through the use of crossbar clamp 3 mounted on the crossbar. The clamp than connects to the interconnecting plate 5. The interconnecting plate then interconnects the crossbar to the roof wing 10 and the supporting roof pedestal 7. The interconnecting plate is bolted to the crossbar and the roof wing assembly through the use of nut and bolt assemblies with locking washers 4 and 9. The downforce roof wing assembly is composed of the wing 10 and the downforce force support pedestal 7. The downforce support pedestal contacts the automobile roof 6 through grommet 12 to ensure stable installation and to prevent damage to the vehicle finish. The front part of the air wing 10 contacts the roof 6 directly for additional stability.

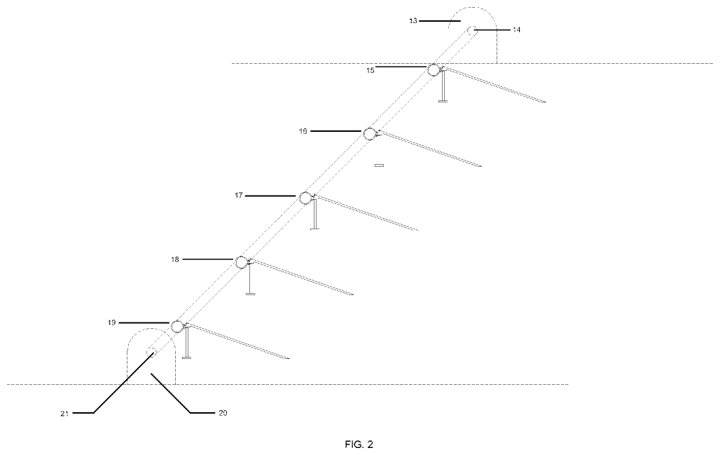

FIG. 2 shows the side perspective view of the roof downforce wing installation mount point clamps 15, 16, 17, 18 and 19 mounted on roof rack crossbar which then attaches at 14 and 21 to the roof rack pedestals 13 and 20. Each roof downforce wing installation mount point clamps 15, 16, 17, 18 and 19 then in turn attach to mount plates 5 that hold the roof downforce wing assembly 10, 7, 12.

The foregoing is offered primarily for purposes of illustration. It will be readily apparent to those skilled in the art that numerous variations, modifications and substitutions of the various elements of structure, function and operation described herein may be made with out departing from the spirit and scope of the invention.

What is claimed is:

1. Vehicle roof downforce wing comprising:
a) Roof downforce wing;
b) Downforce roof air wing support mechanism;
c) Mechanism for attaching the downforce roof air wing to the vehicle roof rack;

2. Vehicle roof downforce wing in accordance with claim 1 in which multiple such mounting mechanisms are installed to ensure safety and reliability of the installation.

3. Vehicle roof downforce wing in accordance with claim 1 in which the vehicle roof downforce wing assembly is mounted on vehicle roof rack for easy installation and modular removal.
